(19) United States
(12) Patent Application Publication
(10) Pub. No.: US 2014/0360320 A1
(43) Pub. Date: Dec. 11, 2014

(54) Multi-jointed driving tool apparatus

(71) Applicants: Glenn Robinson, Parkland, FL (US); Francisco Molina, Margate, FL (US)

(72) Inventors: Glenn Robinson, Parkland, FL (US); Francisco Molina, Margate, FL (US)

(21) Appl. No.: 14/120,576

(22) Filed: Jun. 5, 2014

Related U.S. Application Data
(60) Provisional application No. 61/956,497, filed on Jun. 11, 2013.

(51) Int. Cl. B25B 23/00; B25G 1/06; B25B 15/02

(52) U.S. Cl. CPC B25B 23/0028; B25B 15/02; B25B 23/0021; B25G 1/063
USPC 81/177.8

(57) ABSTRACT

The present invention provides for a multi joint driving tool apparatus comprises a first elongated, a second connecting and a third members pivotally attached to one another and movable to create a plurality of configurations; the third member having a bit holding compartment with an opening for receiving a bit.

### RELATED APPLICATION

This application is related to U.S. Provisional Application Ser. No. 61/956,497 filed on Jun. 11, 2013 entitled “Multi-Jointed Driving Tool Apparatus”.

### BACKGROUND OF THE INVENTION

### Field of the Invention

This invention relates to a tool and more specifically, to a multi jointed driving tool apparatus.

### SUMMARY OF THE INVENTION

In one embodiment, the present invention provides for a multi jointed driving tool apparatus comprising: a first elongated member, a second connecting member, and a third member; the first elongated member has opposing ends, and the first elongated member comprises at least two extended rims, the two extended rims form an indented portion, and the first elongated member comprises a handle situated within the indented portion and between the first and second extended rims, and the handle is designed to freely rotate about an axis the length of the indented portion; a second connecting member has opposing ends, a first end of the connecting member is pivotally attached to the second end of the first elongated member; a third member has opposing ends, a first end of the third member is pivotally attached to the second end of the second connecting member, the third member comprises a bit holding compartment, and the bit holding compartment comprises an opening for receiving a bit, and the opening is situated on a second end of the third member; the first elongated, the second connecting and said third members are designed to be pivotally movable to create a plurality of configurations.

In another embodiment, the apparatus further comprises at least one bit to be received within the opening of the bit holding compartment. In yet another embodiment, the apparatus further comprises a plurality of bits that are designed to be interchangeably received within the opening of the bit holding compartment.

In still another embodiment, the first elongated, second connecting and third members are designed to form at least two pivot points, each of the two pivot points rotate from about 0° to about 180°.

In still yet another embodiment, the first elongated, second connecting and third members are aligned in the same plane forming a generally straight lined apparatus thereby creating a first configuration. In a further embodiment, the second connecting member is on a plane generally perpendicular to the first elongated and third members thereby creating a second configuration. In another further embodiment, the third member is on a plane generally perpendicular to the first elongated and second connecting members thereby creating a third configuration. In yet a further embodiment, the first member is on a plane generally perpendicular to the second connecting and third members thereby creating a fourth configuration. In still a further embodiment, the first elongated and third members are on parallel planes and the second connecting member is on a different non-parallel plane from the first elongated and third members thereby creating a fifth configuration. In still yet a further embodiment, each of the first elongated, second connecting and third members are on three independent planes thereby creating a sixth configuration.

In another embodiment, the second ends of each of the first elongated and the connection members comprise a u-shaped yoke, the yoke has a base and at least two parallel arms extending from the base, each of the arms has an aperture.

In yet another embodiment, the first ends of each of the second connecting and third members comprise at least one protrusion, and the protrusion has an aperture.

In still another embodiment, the protrusion of the second connecting member is inserted in between the two arms of the first elongated member and the apertures of the arms and the protrusion are aligned with one another. In still yet another embodiment, the protrusion of the third member is inserted in between the two arms of the second connecting member and the apertures of the arms and the protrusion are aligned with one another.

In a further embodiment, the apparatus further comprises at least two securing device, a first securing device is inserted with the apertures to pivotally connect the first elongated member to the second connecting member, a second securing device is inserted with the apertures to pivotally connect the second connecting member to the third member.

In another further embodiment, the securing device is selected from a group consisting essentially of bolts, screws, rods, pins and combinations thereof.

In yet another further embodiment, the bit holding compartment further comprises a locking device for securing the bit within the bit holding compartment.

In still another further embodiment, the protrusions of each of the first elongated and second connecting members comprise slots.

In still yet another further embodiment, the base of the yoke of each of the first elongated and second connecting members comprise spring loaded detents, and the detents engage with the slots of the protrusions of the first elongated and second connecting members.

In another embodiment, the present invention provides for a multi jointed driving tool apparatus comprising: a first elongated member, a second connecting member, and a third member; the first elongated member has opposing ends, and the first elongated member comprises at least two extended rims, the two extended rims form an indented portion; a second connecting member has opposing ends, a first end of the connecting member is pivotally attached to the second end of the first elongated member; a third member has opposing ends, a first end of the third member is pivotally attached to the second end of the second connecting member, and the third member comprises a bit holding compartment, the bit holding compartment comprising an opening for receiving a bit, and the opening is situated on a second end of the third member, and at least one bit, and the bit holding compartment comprises a locking device for securing the bit within the bit holding compartment, the first elongated, the second connecting and the third members are designed to be pivotally movable to create a plurality of configurations.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of the multi joint tool of the present invention;

FIG. 2a-d are perspective views of FIG. 1 showing the multiple configurations;

FIG. 3 is an exploded view of FIG. 1; and

FIG. 4 is an exploded view of FIG. 2b.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

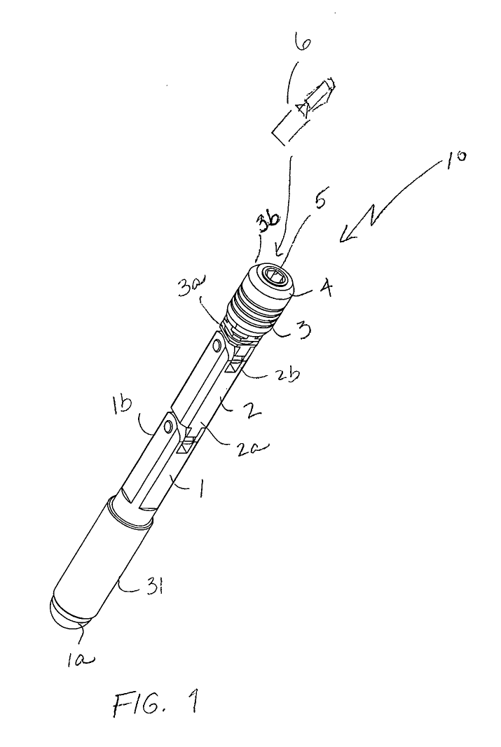

FIGS. 1-4 show a multi jointed driving tool apparatus 10 comprising: a first elongated member 1, a second connecting member 2, and a third member 3. The first elongated member 1 has opposing ends, 1a and 1b respectively, and the first elongated member 1 comprises at least two extended rims, 11a and 11b respectively. The two extended rims 11a and 11b form an indented portion 21, and the first elongated member 1 comprises a handle 31 situated within the indented portion 21 and between the first and second extended rims, 11a and 11b. The handle 31 is designed to freely rotate about an axis the length of the indented portion. The second connecting member 2 has opposing ends, 2a and 2b respectively. A first end 2a of the connecting member 2 is pivotally attached to the second end 1b of the first elongated member 1. A third member 3 has opposing ends, 3a and 3b respectively; a first end 3a of the third member 3 is pivotally attached to the second end 2b of the second connecting member 2.

The third member 3 comprises a bit holding compartment 4, and the bit holding compartment 4 comprises an opening 5 for receiving a bit 6, and the opening 5 is situated on a second end 3b of the third member 3. The first elongated 1, the second connecting 2 and the third members 3 are designed to be pivotably movable to create a plurality of configurations.

FIG. 1 shows the first elongated 1, second connecting 2 and third members 3 are aligned in the same plane forming a generally straight lined apparatus thereby creating a first configuration.

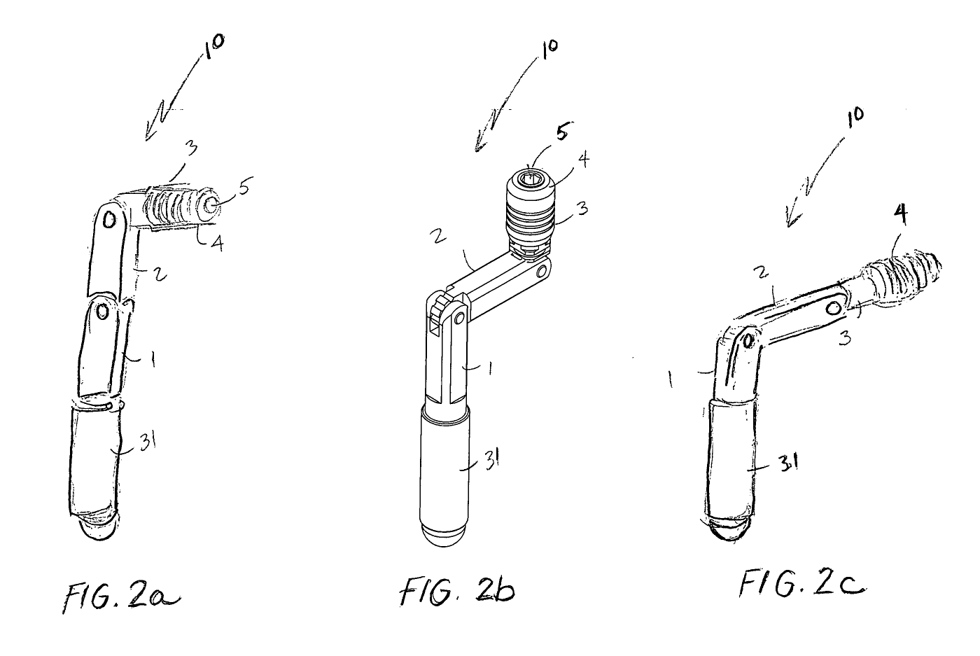

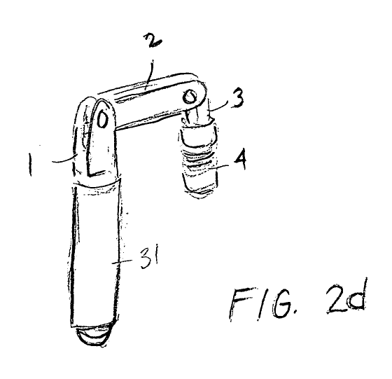

FIG. 2a shows the third member is on a plane generally perpendicular to the first elongated and second connecting members thereby creating another configuration. FIG. 2b shows the first elongated and third members are on parallel planes and the second connecting member is on a different non-parallel plane from (and perpendicular to) the first elongated and third members thereby creating a further configuration. FIG. 2c shows the first member is on a plane generally perpendicular to the second connecting and third members thereby creating another further configuration. FIG. 2d shows the second connecting member 2 is on a plane generally perpendicular to the first elongated 1 and third members 3 thereby creating still another further configuration.

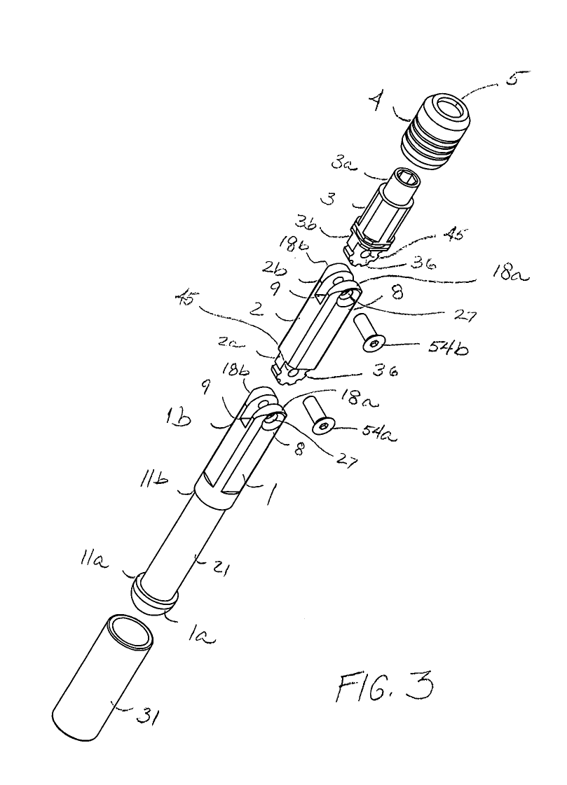

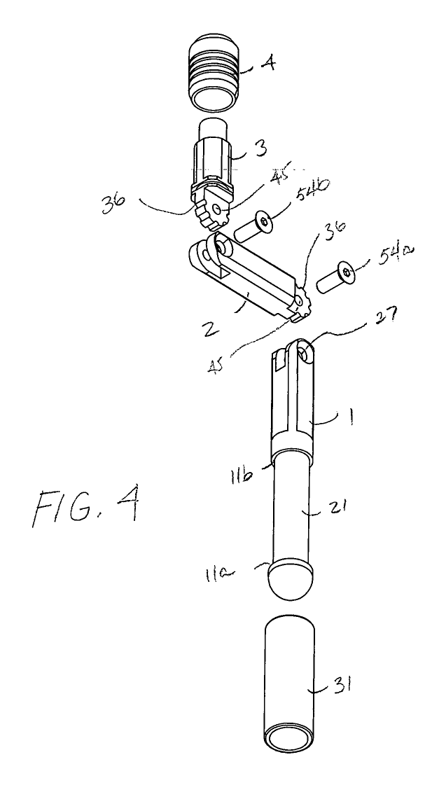

FIGS. 3-4 depict the connection of the members. The second ends 1b of each of the first elongated 1 and the connection 2 members comprise a u-shaped yoke 8, and the yoke 8 has a base 9 and at least two parallel arms, 18a and 18b, extending from the base 9, and each of the arms has an aperture 27. The first ends, 2a and 3a, of each of the second connecting 2 and third 3 members comprise at least one protrusion 36, and the protrusion 36 has an aperture 45.

The protrusion 36 of the second connecting member 2 is inserted in between the two arms, 18a and 18b, of the first elongated member 1 and the apertures 45 of the arms and the protrusion 36 are aligned with one another. The protrusion 36 of the third member 3 is inserted in between the two arms, 18a and 18b, of the second connecting member 2 and the apertures 45 of the arms 18a and 18b, and the protrusions 36 are aligned with one another.

The apparatus 10 further comprises at least two securing device 54a and 54b, a first securing device 54a is inserted with the apertures 45 to pivotally connect the first elongated member 1 to the second connecting member 2, a second securing device 54b is inserted with the apertures 45 to pivotally connect the second connecting member 2 to the third member 3. The securing device 54 can be bolts, screws, rods, pins and any other interchangeable element.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A multi-jointed driving tool apparatus comprising:
a first elongated member, a second connecting member, and a third member;
said first elongated member having opposing ends, said first elongated member comprises at least two extended rims, said two extended rims forming an indented portion, said first elongated member comprises a handle situated within said indented portion and between said first and second extended rims, said handle is designed to freely rotate about an axis the length of said indented portion;
a second connecting member having opposing ends, a first end of said connecting member is pivotally attached to said second end of said first elongated member;
a third member having opposing ends, a first end of said third member is pivotally attached to said second end of said second connecting member, said third member comprising a bit holding compartment, said bit holding compartment comprising an opening for receiving a bit, said opening being situated on a second end of said third member, said first elongated, said second connecting and said third members are designed to be pivotally movable to create a plurality of configurations.

2. The apparatus of claim 1 further comprises at least one bit to be received within said opening of said bit holding compartment.

3. The apparatus of claim 1 further comprises a plurality of bits that are designed to be interchangeably received within said opening of said bit holding compartment.

4. The apparatus of claim 1 wherein said first elongated, second connecting and third members are designed to form at least two pivot points, each of said two pivot points rotate from about 0° to about 180°.

5. The apparatus of claim 1 wherein said first elongated, second connecting and third members are aligned in the same plane forming a generally straight lined apparatus thereby creating a first configuration.

6. The apparatus of claim 1 wherein said second connecting member is on a plane generally perpendicular to said first elongated and third members thereby creating a second configuration.

7. The apparatus of claim 1 wherein said third member is on a plane generally perpendicular to said first elongated and second connecting members thereby creating a third configuration.

8. The apparatus of claim 1 wherein said first member is on a plane generally perpendicular to said second connecting and third members thereby creating a fourth configuration.

9. The apparatus of claim 1 wherein said first elongated and third members are on parallel planes and said second connecting member is on a different non-parallel plane from said first elongated and third members thereby creating a fifth configuration.

10. The apparatus of claim 1 wherein each of said first elongated, second connecting and third members are on three independent planes thereby creating a sixth configuration.

11. The apparatus of claim 1 wherein said second ends of each of said first elongated and said connection members comprise a u-shaped yoke, said yoke has a base and at least two parallel arms extending from said base, each of said arms has an aperture.

12. The apparatus of claim 11 wherein said first ends of each of said second connecting and third members comprise at least one protrusion, said protrusion has an aperture.

13. The apparatus of claim 12 wherein said protrusion of said second connecting member is inserted in between said two arms of said first elongated member and said apertures of said arms and said protrusion are aligned with one another.

14. The apparatus of claim 13 wherein said protrusion of said third member is inserted in between said two arms of said second connecting member and said apertures of said arms and said protrusion are aligned with one another.

15. The apparatus of claim 14 further comprising at least two securing device, a first securing device is inserted with the apertures to pivotally connect said first elongated member to said second connecting member, a second securing device is inserted with the apertures to pivotally connect said second connecting member to said third member.

16. The apparatus of claim 15 wherein said securing device is selected from a group consisting essentially of bolts, screws, rods, pins and combinations thereof.

17. The apparatus of claim 2 wherein said bit holding compartment further comprises a locking device for securing said bit within said bit holding compartment.

18. The apparatus of claim 12 wherein said protrusions of each of said first elongated and second connecting members comprise slots.

19. The apparatus of claim 18 wherein said base of said yoke of each of said first elongated and second connecting members comprise spring loaded detents, said detents engage with said slots of said protrusions of said first elongated and second connecting members.

20. A multi jointed driving tool apparatus comprising:
a first elongated member, a second connecting member, and a third member;
said first elongated member having opposing ends, said first elongated member comprises at least two extended rims, said two extended rims forming an indented portion;
a second connecting member having opposing ends, a first end of said connecting member is pivotally attached to said second end of said first elongated member;
a third member having opposing ends, a first end of said third member is pivotally attached to said second end of said second connecting member, said third member comprising a bit holding compartment, said bit holding compartment comprising an opening for receiving a bit, said opening being situated on a second end of said third member, and
at least one bit, and said bit holding compartment comprises a locking device for securing said bit within said bit holding compartment, said first elongated, said second connecting and said third members are designed to be pivotally movable to create a plurality of configurations.
